(19) United States
(12) Patent Application Publication
(10) Pub. No.: US 2012/0014569 A1
(43) Pub. Date: Jan. 19, 2012

(54) METHOD AND APPARATUS FOR SLIM TYPE FINGERPRINT RECOGNITION DEVICE

(75) Inventors: Fred Frye, Simpsonville, SC (US); Michael Grimes, Boca Raton, FL (US)

(73) Assignee: IB Korea Ltd., Sungnam City (KR)

(21) Appl. No.: 13/184,833

(22) Filed: Jul. 18, 2011

Related U.S. Application Data
(60) Provisional application No. 61/365,081, filed on Jul. 16, 2010.

(51) Int. Cl. G06K 9/00

(52) U.S. Cl. 382/124

(57) ABSTRACT

A mobile slim type fingerprint recognition device has a hand held housing and a light emitting sensor operatively connected to the housing. The light emitting sensor has a transparent insulating layer. A transparent electrode layer overlays the transparent insulating layer. A luminescence layer overlays the transparent electrode layer and a stray light shield layer overlays the luminescence layer. The luminescence layer and the electrode layer are configured such that an electric field can be generated between an object to be imaged and the transparent electrode layer.

This utility patent application claims priority from a provisional application filed on Jul. 16, 2010, having Ser. No. 61/365,081, which is incorporated herein by reference. Inventorship remains the same.

### I. BACKGROUND OF THE INVENTION

A. Field of Invention

The present invention relates to apparatus and methods related to fingerprint recognition devices, and more specifically to thin fingerprint recognition devices that are portable and alternatively, are and can be integrated into other devices.

B. Description of the Related Art

Fingerprint recognition and the use of biometrics is highly recognized and preferred method of identifying individuals, especially for purposes of security. Light emitting sensor (“LES”) technology works differently from both optical and semiconductor scanners. An electrical field is applied to the skin of the finger causing the atoms of the finger to excite and radiate electromagnetic energy (EMF). The multi-layer 200 micron thick film of an LES scanner has a layer that is very sensitive to this energy and radiates light when stimulated by the EMF produced by a live finger.

This luminescence layer provides a uniform and high resolution image. Other layers in the film provide control of ambient light and electrical properties. The thermoplastic protection layer on the top of the film is extremely hard and abrasion and puncture resistant. It is virtually impossible to damage the film in normal use.

This unique material design requires use of a live human finger and makes the LES much more tolerant to substances on the skin or on the surface of the reader and other scanner technologies. Image capture and scanning technology owned by the assignee allows the maximum number of finger print data points to be captured.

Once the image is generated by the LES, a complementary metal-oxide semiconductor (“CMOS”) image scanner (CIS) is utilized to capture the fluorescing image. The image then is enhanced and processed using proprietary algorithms. The minutiae and other information of the fingerprint are mapped, encoded and stored for transmittal or storage.

The foregoing apparatus is more fully described in U.S. Pat. Nos. 6,326,644, 6,993,164 and 6,688,186 all commonly owned by IB Korea Ltd., assignee of the present application. U.S. Pat. Nos. 6,326,644, 6,993,164 and 6,688,186 are incorporated herein by reference. There is a need in the art to incorporate this technology in other devices, such as but not limited to thin mobile devices that function in a stand alone capacity and those that incorporate this technology as one functional component of a larger multi-functional device.

### II. SUMMARY OF THE INVENTION

One object of the present invention is to provide a mobile slim type fingerprint recognition device that may comprise a hand held housing and a light emitting sensor operatively connected to the housing. The light emitting sensor has a transparent insulating layer. A transparent electrode layer overlays the transparent insulating layer. A luminescence layer overlays the transparent electrode layer and a stray light shield layer overlays the luminescence layer. The luminescence layer and the electrode layer are configured such that an electric field can be generated between an object to be imaged and the transparent electrode layer.

Another object of the present invention is to provide a mobile slim type fingerprint recognition device where the hand held housing is a stand alone unit.

Still, another object of the present invention is to provide a mobile slim type fingerprint recognition device where the hand held housing is a multi-modal unit.

Further, another object of the present invention is to provide a mobile slim type fingerprint recognition device further comprising a metal-oxide semiconductor image scanner operatively connected to the light emitting sensor.

Still yet, another object of the present invention is to provide a mobile slim type fingerprint recognition device further comprising a thin film transistor operatively connected to the light emitting sensor.

Another object of the present invention is to provide a mobile slim type fingerprint recognition device where the light emitting sensor further comprises an image platen having a width and a length adapted to simultaneously image capture a plurality of fingerprints.

Further, another object of the present invention is to provide a mobile slim type fingerprint recognition device wherein the light emitting sensor further comprises an image platen having a width and a length adapted to image capture at least one fingerprint.

Another object of the present invention is to provide a mobile slim type fingerprint recognition device wherein the width is about thirty (30) mm.

Still, another object of the present invention is to provide a mobile slim type fingerprint recognition device where the length is about forty (40) mm.

Another object of the present invention is to provide a mobile slim type fingerprint recognition device where the width is about 200 mm.

Further, another object of the present invention is to provide a mobile slim type fingerprint recognition device where the length is about 200 mm.

Still, another object of the present invention is to provide a mobile slim type fingerprint recognition device, where the device has a weight, the weight being less than or equal to 225 grams.

Another object of the present invention is to provide a mobile slim type fingerprint recognition device further comprising a rechargeable battery operatively connected to the light emitting sensor and positioned within the housing.

Further, another object of the present invention is to provide a mobile slim type fingerprint recognition device further comprising an image camera operatively connected to the light emitting sensor, wherein the image camera is adapted to capture a fingerprint image.

Another object of the present invention is to provide a mobile slim type fingerprint recognition device where the light emitting sensor is adapted to obtain a fingerprint image via a roll scan.

Still yet, another object of the present invention is to provide a mobile slim type fingerprint recognition device, wherein the fingerprint image is up to 1000 dpi.

Another object of the present invention is to provide a method for capturing a fingerprint image comprising the steps of providing a mobile slim type fingerprint recognition device comprising; a hand held housing, a light emitting sensor operatively connected to the housing, the light emitting sensor comprising a transparent insulating layer, a transparent electrode layer overlaying the transparent insulating layer, a luminescence layer overlaying the transparent electrode layer and a stray light shield layer overlaying the luminescence layer, wherein the luminescence layer and the electrode layer are configured such that an electric field can be generated between an object to be imaged and the transparent electrode layer; apply a finger to the light emitting sensor; capture a fingerprint image via an image camera; converting the fingerprint to a template; storing the fingerprint in memory of the device; and matching the fingerprint with other fingerprints available on the device or a separate location.

Still yet, another object of the present invention is provide a method for capturing a fingerprint image further comprising the step of returning results from the step of matching the fingerprint with other fingerprints available on the device or a remote location to the mobile device.

Another object of the present invention is provide a slim type fingerprint recognition device, wherein the weight is up to 675 grams.

Still yet, another object of the present invention is provide a method for capturing a fingerprint image wherein the step of converting the fingerprint to a template further comprises the steps of transmitting the captured fingerprint image to a server at a separate location; and converting the captured fingerprint image to the template.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a perspective view of the present invention.

FIG. 2 is a front elevational view of one feature of the present invention.

FIG. 3 is another perspective view of another embodiment of the present invention.

FIG. 4 is front elevational view of another aspect of the present invention.

FIG. 5 is a flow chart illustrating the present invention.

FIG. 6 is a front elevational view of another aspect of the present invention.

FIG. 7 is a perspective view of another embodiment of the present invention.

FIG. 8 is a perspective view of the present invention.

FIG. 9 is a cross-sectional view of the present invention.

FIG. 10 is a side view of FIG. 9.

FIG. 11 is a perspective view of another embodiment of the present invention.

FIG. 12 is a cross-sectional view of a component of the present invention.

### IV. DESCRIPTION OF THE PREFERRED EMBODIMENT

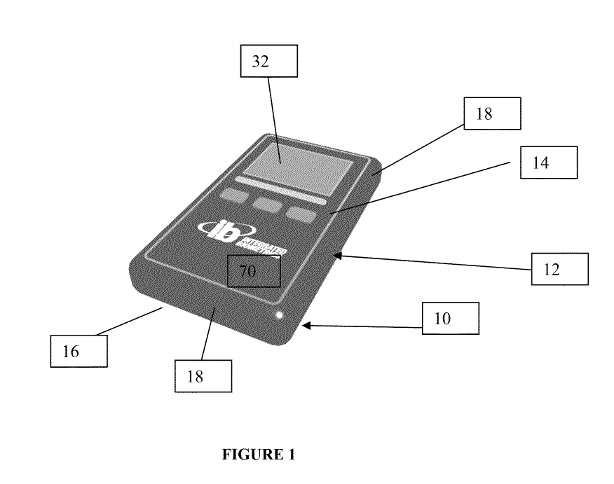

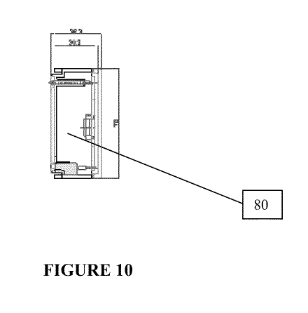

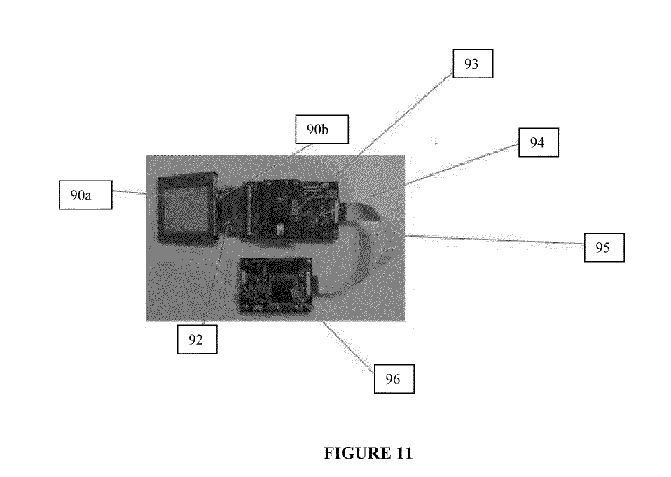

Referring now to the drawings wherein the showings are for purposes of illustrating a preferred embodiment of the invention only and not for purposes of limiting the same, FIGS. 1-12 illustrate various aspects of the present invention.

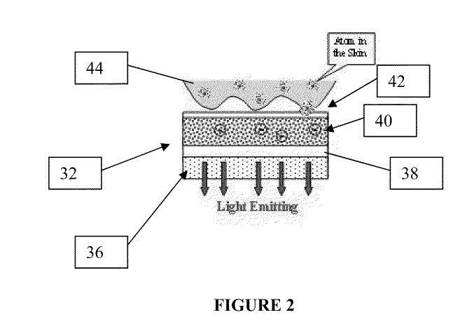

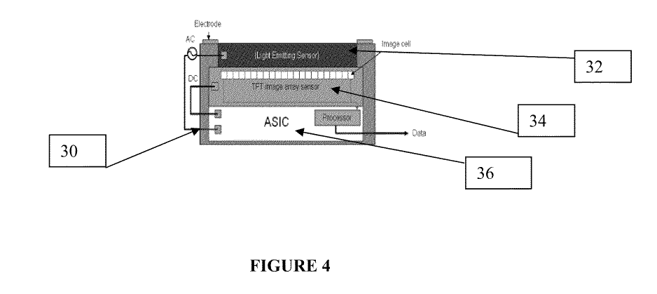

Referring now to the drawings wherein the showings are for purposes of illustrating a preferred embodiment of the invention only and not for purposes of limiting the same, FIG. 1, a mobile slim type fingerprint recognition device 10 comprises a hand held housing 12, with an upper surface 14 and oppositely disposed lower surface 16. The upper surface 14 and lower surface 16 are interconnected by a plurality of sides 18. The housing 12 integrates the a contact type light emitting sensor 32 operatively connected with a thin film transistor (TFT) fingerprint input device 34 (as shown in FIG. 4). As shown in FIG. 2, the light emitting sensor 32 further comprises a transparent insulating layer 36. A transparent electrode layer 38 overlays the transparent insulating layer 36. A luminescence layer 40 overlays the transparent electrode layer 38 and a stray light shield layer 42 overlays the luminescence layer 40. The luminescence layer 40 and the electrode layer 38 are configured such that an electric field can be generated between an object 44 to be imaged and the transparent electrode layer 38. Further discussion about these layers and their interaction are more fully described in assignee's U.S. Pat. Nos. 6,326,644, 6,993,164 and 6,688,186.

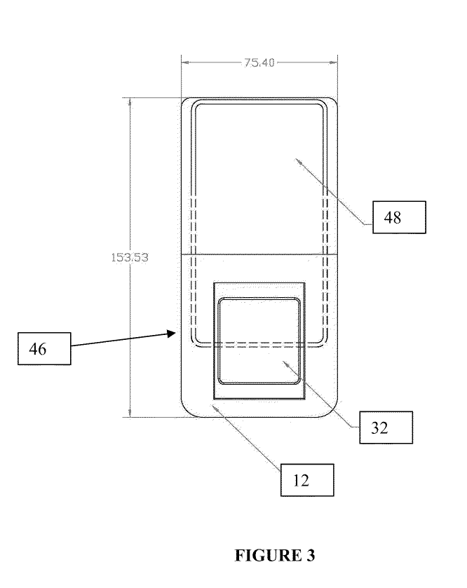

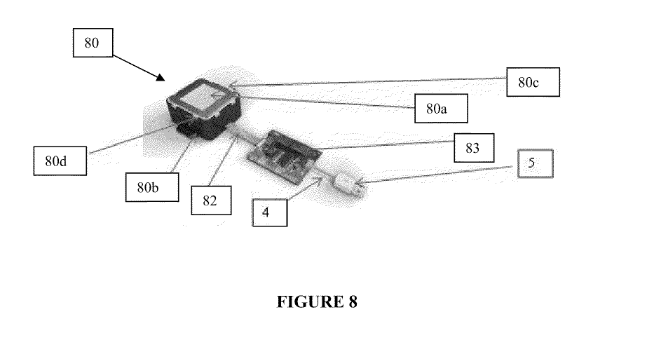

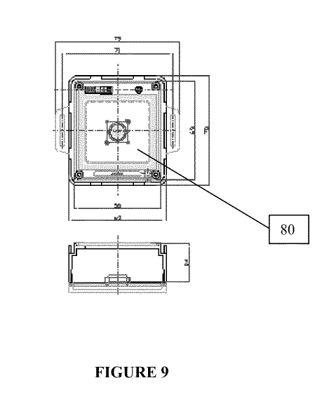

In one embodiment of the present invention the device 10 may be utilized as a stand alone unit as shown in FIG. 1. Likewise, the light emitting sensor 32 can also be used with a complementary metal-oxide semiconductor (“CMOS”) image scanner (CIS) as shown in FIGS. 8-10. As shown in FIGS. 8-10, the light emitting sensor 32 takes the form of a CIS sensor 80. The CIS Sensor 80 comprises light emitting film 80a operatively connected to a light emitting driver board with CIS 80b, both of which are secured to a casing 80c with a gasket 80d. A cable 82 transmits a signal from the CIS sensor 80 to a USB board 83. A USB cable 84 further transmits the signal from the USB board 83 to a USB plug 85. The USB plug 85 can then be coupled to another device, such as a computer, phone, etc. for processing of captured biometric data. In another embodiment of the present, the device 10 may be a multi-modal unit integrated or embedded into another application, such as a smart phone or other telecommunications device, or computer as shown in FIG. 3. In FIG. 3, the light emitting sensor 32 and TFT is shown embedded into a multi-modal or finger print only hand held device 46, which is connected to an mobile phone 48. As in the standalone version, the embedded version can also use the CMOS (CIS Image Sensor). The multi-modal unit could utilize a wide array of biometric identifiers such as fingerprint, palm prints, iris recognition, facial recognition and retinal recognition or any other physiological biometric measure.

It is contemplated to be within the scope of the invention that the light emitting sensor 32 may be adapted to scan from one finger up to ten fingers. The finger scans may be taken by rolling the finger to capture a “nail to nail” image of the fingerprint. As per U.S. Pat. No. 6,993,164, the process works as follows with both a complementary metal-oxide semiconductor (“CMOS”) image scanner (CIS) and the thin film transistor (TFT) capturing system. The device 10 of the present invention includes finger print sensing device unit, a CCD device unit and an image processing unit. The image processing unit is comprised of either the complementary metal-oxide semiconductor (“CMOS”) image scanner (CIS) or the TFT image capturing system. An Analog/Digital converting unit (A/D) for converting and outputting the finger print image outputted from the CCD device unit into a digital signal. An image buffer is utilized for storing the digital signal from the A/D converting unit. A controller for watching a state of the image buffer, i.e. whether the fingerprint image is inputted and stored to the image buffer and storing the finger print image is confirmed.

The size of the fingerprint recognition device may range from about 16 millimeters by about 18 millimeters to about 10 inches by 15 inches. All increments between these ranges are contemplated to be suitable for the present invention and are hereby disclosed. In order to accommodate the sizing of the fingerprint recognition device, the following dimensions serve as a possible example for the overall device 10 and may be as follows:

Product Size

| | Length (mm) | Width (mm) | Thickness (mm) | Weight |
|---|---|---|---|---|
| Standalone | 120.0 | 70.0 | 18.0 | <8 ounces |
| Product | | | | |
| Embedded | 50.0 | 40.0 | 18.0 | <4 ounces |
| Product | | | | |
| Image Platen | 40.0 | 30.0 | 0.2 | |

Other features of the present invention include ensuring whether the device 10 is portable. The device is contemplated to utilize Blue Tooth, Wi-Fi, and a tethered USB port, connection to a secondary device. Due to the large amount of data involved, most connections to the secondary device will pass through customized connection or through a USB designed interface. In certain applications, Wi-Fi, a local area network that uses high frequency radio signals to receive and transmit data over distances using an Ethernet protocol could be employed, in other instances, Bluetooth a proprietary open wireless protocol for exchanging data over short distances (using short length radio waves) could also be used. It may also include cell phone communication. The present invention may also have global positioning system capabilities. It is also contemplated that the device 10 may be utilized in conjunction with a global computer network. It is also contemplated that the device 10 may utilize a keyboard and display in order to input data after a fingerprint is scanned into the device 10, such as for identifying the person connected with a particular scan or other particulars such as date, time and location of such scan. Any feature utilized with the global system mobility is also contemplated to be within the scope of the invention, including without limitation use of a smart card, or other removable memory storage cards and voice, email, and text capabilities. In another embodiment of the present invention, the device 10, which may be either mobile or embedded into a secondary device, can serve as a substitute security feature, thereby eliminating traditional security measures, such as but not limited to passwords, key codes, fobs, key cards and the like.

Extended battery life is yet another feature of the present invention. Extended battery life may range anywhere from about five hours to about thirty-six (36) hours. It is contemplated that every increment of time in between this range is contemplated to be within the scope of the present invention. The energy is conserved as follows. The electronics in the embedded or standalone product will support a sleep mode where only a detection circuit is powered. This circuit will use less than 1 milliampere to keep it activated. A wake up command is required to put it into operation mode. This wake up command will come from the user interface device. Once the wake up command is generated, the electronics and processor are running and the expected power consumption is approximately 100-120 milli-amperes. When the fingerprint scanner has been activated an additional 20-30 milli-amperes will be required. The maximum expected power consumption is 120-150 milli-amperes at 5 volts DC. The scan system is enabled for 10 seconds. This timeout on the scan system can be designed around requirements. In sleep mode, the power consumption will be 0.3 watts/hour or 7.2 Watts per day. Assuming the 10 second enrollment process, power consumed in enrolling 10 suspects would be 75 watts. The battery saving circuit design will enable the user to have longer active live of the inventive device 10 in the field of use without the need for constant recharging.

With respect to FIG. 4, the image capturing process will now be further described. In order to minimize the thickness of the device 10, a TFT image array sensor may be utilized rather than a CIS device. A CIS device still may be utilized, however, it will effect the dimensions of the overall device.

The TFT array sensor 34 uses a network of photo sensitive diodes which is a type of photo detector capable of converting light into an electrical signal. In one embodiment of the present invention, the photodiode is connected to thin film silicon transistors, which are used to connect to external circuits. The operation of the TFT in this product is explained fully in U.S. Pat. No. 6,688,186. Generally, a TFT finger print input device has a structure where a plurality of unit cells including a light sensing unit and a switching unit are aligned and are adhered to the light emitting sensor 32 by an adhesive layer or through lamination.

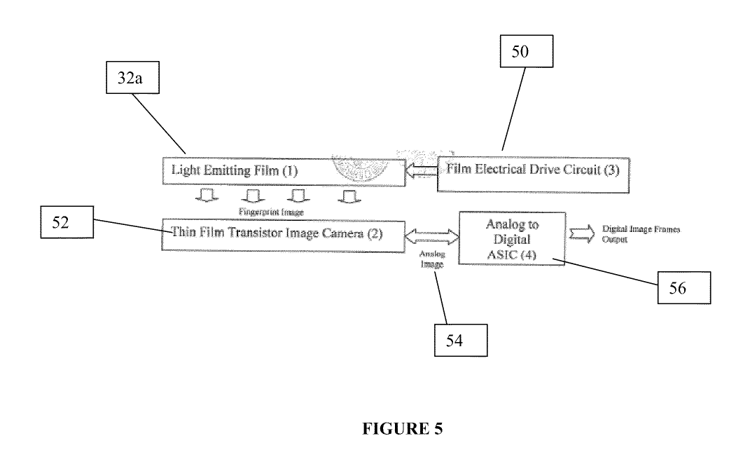

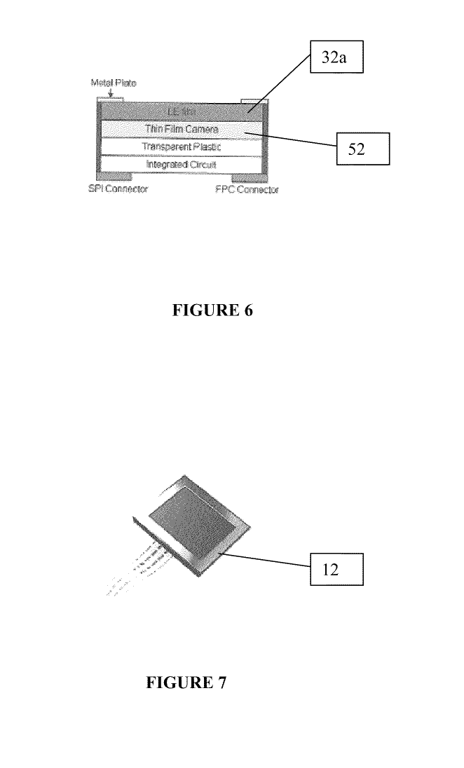

The TFT being used in this invention is a special TFT designed to meet the needs of a fingerprint roll scanner. FIG. 5 outlines the process flow and an image of the one embodiment of the present invention and FIG. 6 is an elevational view of such components. FIG. 7 shows a representation of the TFT and light emitting sensor 12 in conjunction of the embodiment illustrated in FIG. 6. As shown in FIG. 2, the object 44, such as a person's finger, is positioned on the light emitting sensor 32, also referred to sometimes as the light emitting film 32a. As shown in FIG. 5, a film electrical drive circuit 50 energizes as a result, and a fingerprint image is captured by a thin film transistor image camera 52 as an analog image 54. The analog image is then converted into a digital image 56, which is the ultimate output. The specifications of the TFT are specific in that it may be built between 400 DPI and 1000 DPI. In order to achieve the roll scan performance from the film and TFT, a specific integrated circuit 56 is required. This circuit will be designed to achieve 7 to 15 frames per second image capture speed for a 500 to 1000 dpi sensor.

The present invention will eliminate the need for caring auxiliary roll print scanners creating weight savings, and its durability and ruggedness will create longer life in the field of operation.

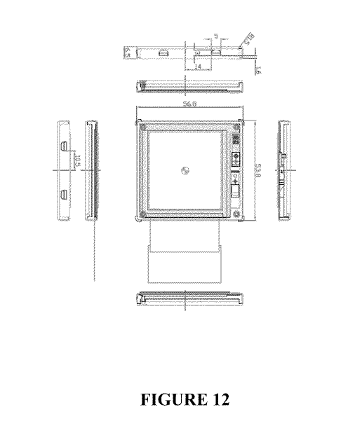

Other specifications for the present invention include the sensor type may be a light emitting sensor 32 in conjunction with the TFT as shown in FIGS. 11 and 12. In FIGS. 11 and 12, the light emitting sensor 32 takes the form of a TFT Sensor 90. The TFT sensor 90 comprises light emitting film 90a and a thin film transistor 90b. A FPC cable 92 operatively connects the TFT sensor 90 to the light emitting driver board 93. The light emitting driver board 93 is coupled to an A/D board 94. A cable 95 interconnects and transmits signals from the A/D board 94 to the USB board 96. The USB board 96 may then be connected into an appropriate device for processing of captured biometric data.

Resolution may be up to or even exceeding 1,000 dpi. The light source may be an LES film. The active area size may be 200×200 millimeters. The device 10 stand alone embodiment may have the dimensions of 230×230×50 millimeters. An embedded device 10 may have the dimensions of 200×200×45 millimeters. The interface may utilize a USB 2.0. Input voltage may be about 5.0 volts. The ESD may be 15 KV by air or 8 KV by contact. The ESD may be 15 KV by air or 8 KV by contact. The operating temperature may range from −10 to 60 degree Celsius. The weight may be less than eight ounces or 225 grams.

For the standalone version the embedded module would be mounted into a small thin enclosure, with internal rechargeable battery 70 (shown schematically in FIG. 1). In this configuration, user interface device would be inside the standalone device and would operate as outlined below in the Embedded Module Operation.

The embedded version biometric module will be connected to a user interface device through a high speed USB connection. The User Interface for purposes of this application will be a hand held computer. A SDK (software and instruction set) will be installed on the hand held computer and it will only be used to utilize the enrollment and matching capabilities of the module. The hand held computer will issue commands to the module and will support basic commands such as “Enroll a User,” “Identify a User,” “Verify a User,” as well as utility commands to capture and upload fingerprint images or templates. The module will operate in either “rolled” fingerprint mode or “direct fingerprint” image mode. The basic operational modes are “Enrolling” and “Matching.” For “Enrolling,” the user interface device will send a command and unique identifier, (for example “John Doe”) to “enroll” the user. The module turns on and waits for the fingerprint to be applied to the scanner. The results (either “successful” or “timeout”) of the process are returned to the user interface device. If successful, the fingerprint has been converted to a template and stored in the device flash memory. If “timeout” has occurred, the process must be repeated until successful. For “Matching,” the user interface device sends a match command (one- to-one or one-to-many) to the module. The module turns on, captures the fingerprint and attempts to match it to fingerprint templates stored locally in its internal flash memory. The results are communicated back to the user interface device. For example, “Successfully matched John Doe.”

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

What is claimed is:

1. A mobile slim type fingerprint recognition device comprising:
a hand held housing;
a light emitting sensor operatively connected to said housing, said light emitting sensor comprising:
a transparent insulating layer;
a transparent electrode layer overlaying said transparent insulating layer;
a luminescence layer overlaying said transparent electrode layer; and;
a stray light shield layer overlaying said luminescence layer, wherein the luminescence layer and the electrode layer are configured such that an electric field can be generated between an object to be imaged and said transparent electrode layer.

2. The mobile slim type fingerprint recognition device of claim 1, wherein said hand held housing is a stand alone unit.

3. The mobile slim type fingerprint recognition device of claim 1, where said hand held housing is a multi-modal unit.

4. The mobile slim type fingerprint recognition device of claim 1, further comprising a metal-oxide semiconductor image scanner operatively connected to said light emitting sensor.

5. The mobile slim type fingerprint recognition device of claim 1, further comprising a thin film transistor operatively connected to said light emitting sensor.

6. The mobile slim type fingerprint recognition device of claim 1, wherein said light emitting sensor further comprises an image platen having a width and a length adapted to simultaneously image capture a plurality of fingerprints.

7. The mobile slim type fingerprint recognition device of claim 6, wherein said width is about thirty (30) mm.

8. The mobile slim type fingerprint recognition device of claim 6, wherein said length is about forty (40) mm.

9. The mobile slim type fingerprint recognition device of claim 6, wherein said width is about 200 mm.

10. The mobile slim type fingerprint recognition device of claim 6, wherein said length is about 200 mm.

11. The mobile slim type fingerprint recognition device of claim 1, wherein said device has a weight, said weight being less than 225 grams.

12. The mobile slim type fingerprint recognition device of claim 1, further comprising a rechargeable battery operatively connected to said light emitting sensor and positioned within said housing.

13. The mobile slim type fingerprint recognition device of claim 1, further comprising an image camera operatively connected to said light emitting sensor, said image camera adapted to capture a fingerprint image.

14. The mobile slim type fingerprint recognition device of claim 1, wherein said light emitting sensor is adapted to obtain a fingerprint image via a roll scan.

15. The mobile slim type fingerprint recognition device of claim 13, wherein said fingerprint image is up to 1000 dpi.

16. A method for capturing a fingerprint image, comprising the steps of:
providing a mobile slim type fingerprint recognition device comprising:
a hand held housing;
a light emitting sensor operatively connected to said housing, said light emitting sensor comprising:
a transparent insulating layer;
a transparent electrode layer overlaying said transparent insulating layer;
a luminescence layer overlaying said transparent electrode layer; and;
a stray light shield layer overlaying said luminescence layer, wherein the luminescence layer and the electrode layer are configured such that an electric field can be generated between an object to be imaged and said transparent electrode layer;
apply a finger to said light emitting sensor;
capture a fingerprint image via an image camera;
converting said fingerprint to a template;
storing said fingerprint in memory of said device; and
matching said fingerprint with other fingerprints available on said device or a separate location.

17. The method of claim 16, further comprising the step of:
returning results from the step of matching said fingerprint with other fingerprints available on said device or a remote location to the mobile device.

18. The method of claim 16, wherein said device is a stand alone unit.

19. The method of claim 16, wherein said device is a multi-modal unit.

20. The method of claim 16, wherein said device has a length, a width, and a weight, wherein said length is up to 200 mm, said width is up to 200 mm, and said weight is up to 675 grams.

21. The method of claim 16, wherein said step of converting said fingerprint to a template further comprises the steps of:
transmitting said captured fingerprint image to a server at a separate location; and
converting said captured fingerprint image to said template.
